(19) United States
(12) Patent Application Publication
(10) Pub. No.: US 2008/0152322 A1
(43) Pub. Date: Jun. 26, 2008

(54) AUDIO AND VIDEO REPRODUCING APPARATUS AND AUDIO AND VIDEO REPRODUCING METHOD

(75) Inventor: Atsushi ONODA, Fussa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/773,052

(22) Filed: Jul. 3, 2007

(30) Foreign Application Priority Data
Dec. 25, 2006 (JP) 2006-347609

(51) Int. Cl. H04N 5/00

(52) U.S. Cl. 386/126; 386/E05.064

(57) ABSTRACT

According to one embodiment, an audio and video reproducing apparatus includes an HD DVD drive that reproduces an HD DVD in accordance with HD DVD standards, a digital interface that makes a connection between the HD DVD drive and another apparatus and transmits a reproduction signal of the HD DVD from the HD DVD drive to the another apparatus, and a controller that stores an information regarding reproduction stop of the HD DVD and a bookmark corresponding to the information in a storage part using a bookmark function defined in the HD DVD standards, when the connection is disconnected during a playback of the HD DVD.

### CROSS-REFERENCE TO RELATED APPLICATIONS

This application is based upon and claims the benefit of priority from Japanese Patent Application No. 2006-347609, filed Dec. 25, 2006, the entire contents of which are incorporated herein by reference.

### BACKGROUND

1. Field

One embodiment of the invention relates to an audio and video reproducing apparatus and an audio and video reproducing method, for example, video and sound data obtained by reproducing a digital versatile disc (DVD) is transmitted via a digital interface to an electronic apparatus such as a display unit.

2. Description of the Related Art

Digital television broadcasting has fully fledged, and a digital broadcasting receiver (i.e., TV), a DVD recorder, a hard disk (HDD) recorder and a DVD player, which support this digital broadcasting, are available on the market. Also, in recent years, a high definition digital versatile disc (HD DVD) that is writable and readable using a blue laser has been developed, and an HD DVD player for playing back the HD DVD is available on the market. Generally, a HDD player or the DVD player has a bookmark function of recording the reproduction position during playback, and thereafter making the reproduction from the reproduction position. It is disclosed by, for example, Japanese Patent Application Publication (KOKAI) No. 2006-13935 and Japanese Patent Application Publication (KOKAI) No. 2004-274287.

The recorder or player describe above is connected to a digital TV or personal computer via a high speed interface such as a universal serial bus (USB) or IEEE1394.

Recently, a high definition multimedia interface (HDMI) for AV appliances has been publicized. It is expected that the HDMI will be mainstream of the digital interface for connecting the HDD or DVD recorder/player and the digital TV in the future. The HDMI can transmit a video signal and a sound signal through one cable and transmit the resolution or aspect information, a mutual authentication signal of copyright, and a control signal between electronic apparatuses such as for turning on/off the power.

However, in the bookmark function of the related audio and video reproducing apparatus, the user manually generates the bookmark. When the reproducing apparatus was disconnected from the display side, such as when the power of the digital TV was turned off, the audio and video reproducing apparatus could not resume operation because the stop position was not stored therein. Thus, the user had to perform manually the reproduction from the beginning, or detect the stop position by rewinding or fast forwarding, so that usability was not good.

When the audio and video reproducing apparatus and the display unit are connected via the HDMI, a connection information is monitored by the HDMI, and when the power of the digital TV is turned off, the reproduction of the HD DVD is stopped. However, the information of the stop position is not stored. Thus, even when the digital interface such as the HDMI is employed, the audio and video reproducing apparatus can not resume operation.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing an audio and video reproducing system according to an embodiment of the present invention;

FIG. 2 is an exemplary block diagram of an audio and video reproducing apparatus according to the embodiment;

FIG. 3 is an exemplary flowchart showing a process up to reproduction stop of the audio and video reproducing apparatus according to the embodiment;

FIG. 4 is an exemplary flowchart showing a process for resuming the reproduction owing to connection recovery of the HDMI from the reproduction stop as shown in FIG. 3 in the embodiment; and

FIG. 5 is an exemplary screen view showing a screen example displayed on a monitor or TV at the time of resuming the reproduction according to the embodiment.

### DETAILED DESCRIPTION

Various embodiments according to the invention will be described hereinafter with reference to the accompanying drawings. In general, according to one embodiment of the invention, an audio and video reproducing apparatus includes an HD DVD drive that reproduces an HD DVD in accordance with HD DVD standards, a digital interface that makes a connection between the HD DVD drive and another apparatus and transmits a reproduction signal of the HD DVD from the HD DVD drive to the another apparatus, and a controller that stores an information regarding reproduction stop of the HD DVD and a bookmark corresponding to the information in a storage part using a bookmark function defined in the HD DVD standards, when the connection is disconnected during a playback of the HD DVD.

Embodiments of the present invention will be described below in detail with reference to the drawings.

### (Configuration of Audio and Video Reproducing System)

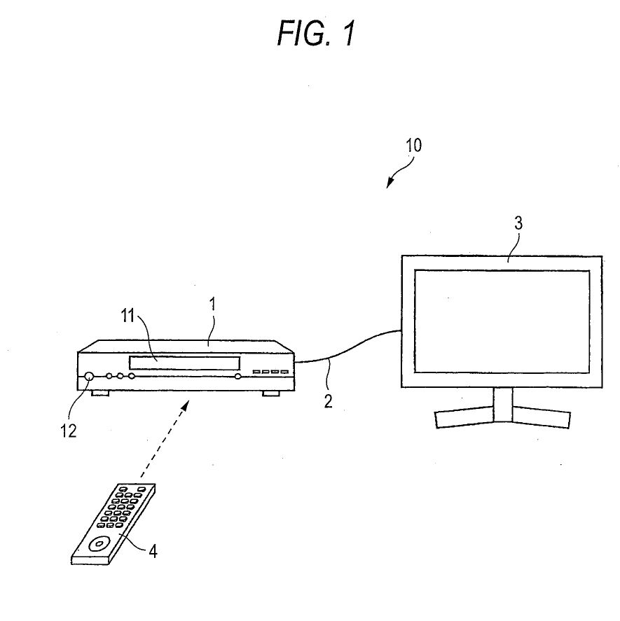

FIG. 1 shows an exemplary audio and video reproducing system according to an embodiment of the invention. This audio and video reproducing system 10 includes an audio and video reproducing apparatus 1 that can reproduce an HD DVD that is a recording medium, a broadcasting receiver (TV) 3 connected to the audio and video reproducing apparatus 1 via one cable 2, and a remote controller 4 that can remotely control the audio and video reproducing apparatus 1 and the TV 3.

The audio and video reproducing apparatus 1 is provided with a monitor (liquid crystal display) 11 for displaying the operating state and a power switch 12 on a front panel thereof. Also, the audio and video reproducing apparatus 1 mounts a hard disk drive and an HD DVD drive as a storage media. The audio and video reproducing apparatus 1 may include a tuner for receiving a digital broadcasting.

The cable 2 is an exclusive HDMI cable connectable to an HDMI terminal, in which a connector having 16 connector pins is attached at either end.

The TV 3, on which the high vision broadcasting can be watched separately, has a plurality of HDMI input terminals connectable to the audio and video reproducing apparatus 1 as well as a personal computer (not shown).

### (Internal Configuration of Audio and Video Reproducing Apparatus)

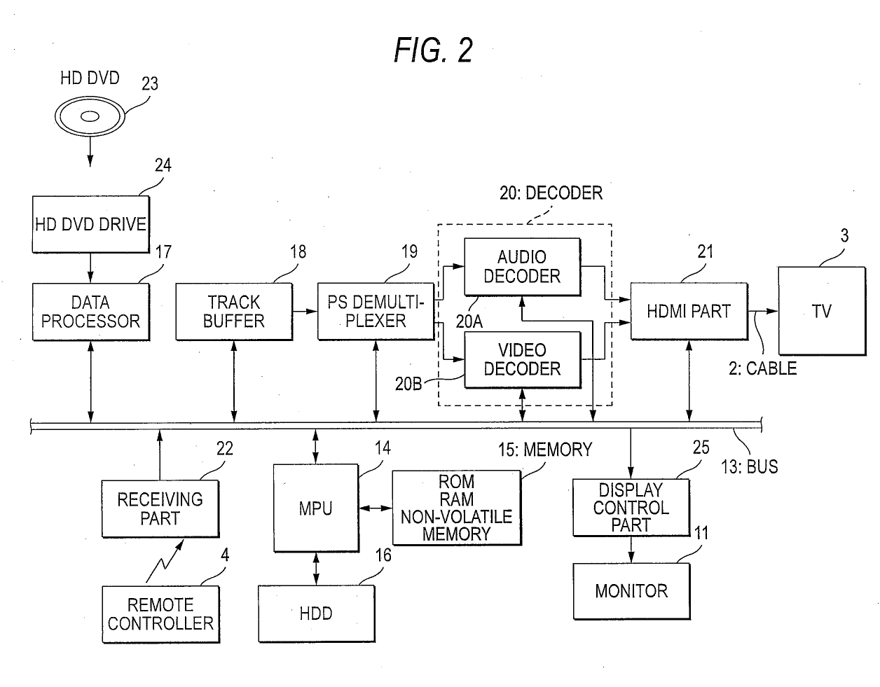

FIG. 2 shows an exemplary block diagram of the audio and video reproducing apparatus 1 according to the embodiment. The audio and video reproducing apparatus 1 has a micro processing unit (MPU) 14 as a controller that is connected to a bus 13 (including a data bus, a control bus and an address). The MPU 14 is connected to a memory 15 having a ROM, a RAM and a non-volatile memory for storing the bookmark information, composed of semiconductor memory and an HDD 16 for storing the image data.

A data processor 17 for processing the reproduced output, a track buffer 18 connected to the data processor 17, a program stream (PS) demultiplexer 19 connected to the track buffer 18, a decoder 20 connected to the PS demultiplexer 19, an HDMI part 21 connected to the decoder 20 and the TV 3, a receiving part 22 for receiving an infrared signal from the remote controller 4 and a display controller 25 for controlling the display on a monitor 11 are connected to the bus 13. An HD DVD drive 24 for outputting a reproduction signal of the HD DVD 23 to the data processor 17 is connected to the data processor 17.

The data processor 17 is configured to process an output signal form the DVD drive 24 and output a signal regarding the DVD to the track buffer 18.

The track buffer 18 is configured to output a predetermined amount of stream data from the data processor 17 to the PS demultiplexer 19.

The PS demultiplexer 19 is configured to demultiplex data from the track buffer 18 into an audio signal and a video signal for output to the decoder 20.

The decoder 20 includes an audio decoder 20a for decoding an audio signal from the PS demultiplexer 19 and a video decoder 20b for decoding a video signal from the PS demultiplexer 19. The decoder 20 is configured to output respective decoded signals to the HDMI part 21.

The HDMI part 21 is configured to transmit the audio data and video data from the decoder 20, with transaction minimized differential signaling (TMDS) data, +TDMS clock, consumer electronics control (CED), serial clock (SCL), serial data (SDA), and display data channel (DDC), and receive a hot plug detection signal.

The receiving part 22 is configured to receive and decode an infrared signal from the remote controller 4 and output the decoded signal to the bus 13.

The HD DVD drive 24 is configured to be usable with not only the HD DVD of read-only, write once and rewritable media but also an existent DVD.

### (Operation of Audio and Video Reproducing Apparatus)

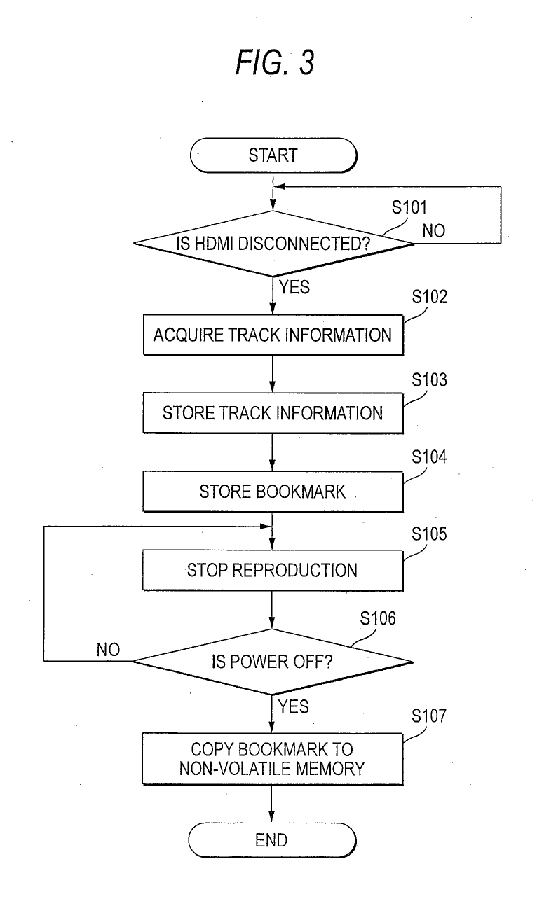

FIG. 3 shows an exemplary process up to the reproduction stop of the audio and video reproducing apparatus 1 according to the embodiment.

When powers of the audio and video reproducing apparatus 1 and the TV 3 are turned on, and the HD DVD 23 is loaded into the HD DVD drive 24, the HD DVD 23 is reproduced, and a reproduced image of the HD DVD 23 is displayed on the TV 3. At this time, the MPU 14 polls the connection state of the HDMI part 21 at every predetermined period of time or at predetermined timings (S101).

When the HDMI part 21 is disconnected from the TV 3 (S101: Yes) by turning off the power of the TV 3 during playback of the HD DVD 23, the MPU 14 calls the “application program interface (API) Player.bookmark.save( )” as defined in the HD DVD standards. Thereby, the MPU acquires the title information (title number), the reproduction time (elapsed time), and the information regarding the reproduction stop such as audio subtitle, as the track information, for the HD DVD 23 being reproduced at present by the audio and video reproducing apparatus 1 (S102), and stores this track information in the HDD 16 (S103). Also, the bookmark information for the track information is stored as the bookmark in the RAM of the memory 15 (S104). Thereafter, the MPU 14 stops the operation of the HD DVD drive 24 (S105).

After the reproduction of the HD DVD 23 is stopped at step S105, when the power switch 12 is pressed and the power of the audio and video reproducing apparatus 1 is turned off (S106: Yes), the bookmark information stored in the RAM of the memory 15 is copied to the non-volatile memory of the memory 15 (S107). Through this process, the reproduction is allowed from the designated bookmark position even after turning on the power again.

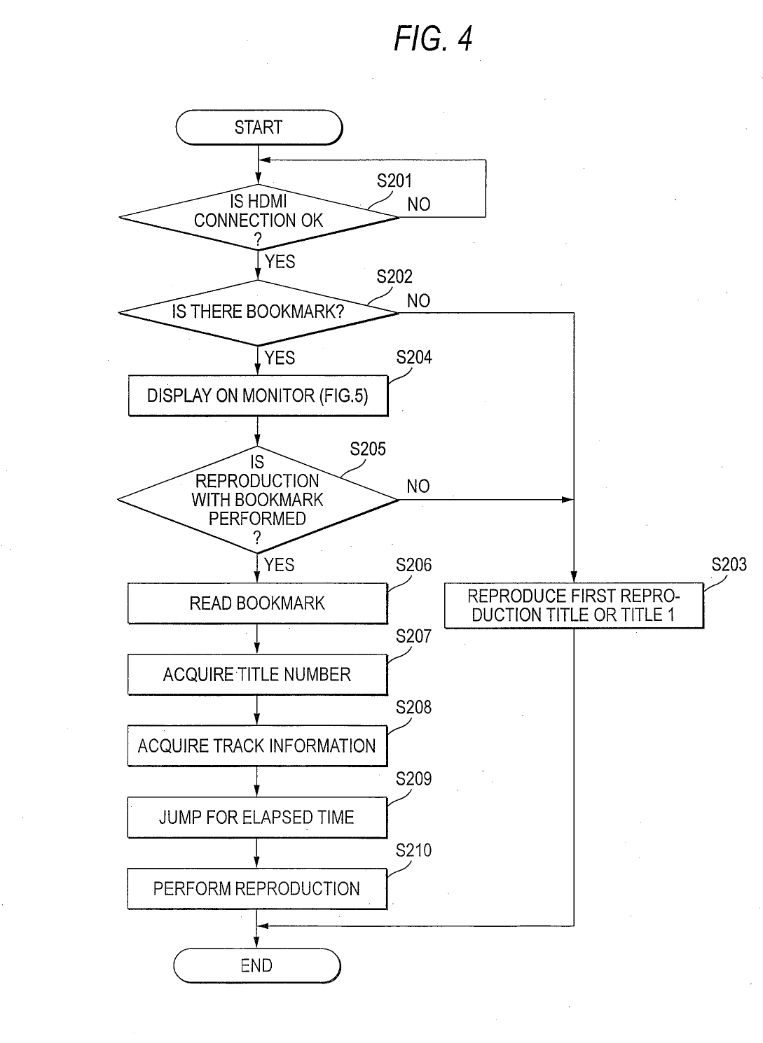

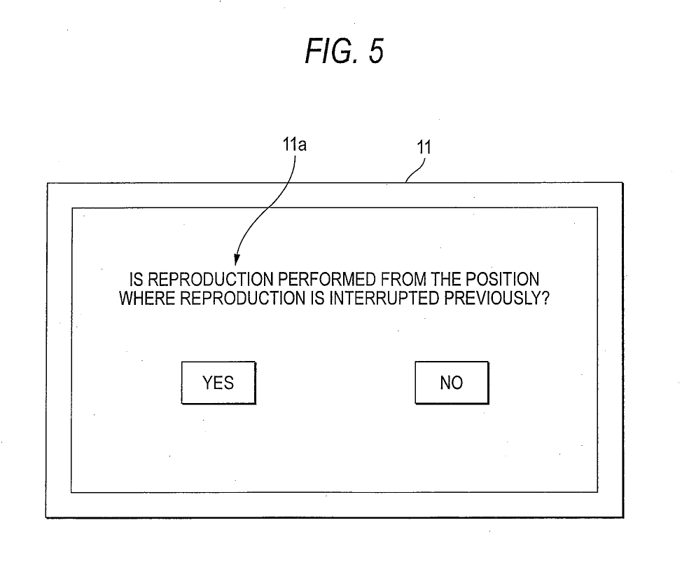

FIG. 4 shows an exemplary process for resuming the reproduction owing to the connection recovery of the HDMI from the reproduction stop of the HD DVD as shown in FIG. 3 in the embodiment. Also, FIG. 5 shows one example of a screen displayed on the display of the monitor 11 or the TV 3 at the time of resuming the reproduction according to the embodiment.

After disconnecting the HDMI at S101, the power of the TV 3 is turned on, and if the connection of the HDMI between the TV 3 and the audio and video reproducing apparatus 1 is recovered (S201: Yes), the MPU 14 calls the “API Player. bookmark jump( )”. If the API is called, the reproduction can be resumed from the reproduction time with the disconnected title.

After resuming the connection of the HDMI (S201: Yes), the MPU 14 checks the presence or absence of the bookmark (S202). When the connection of the HDMI can be confirmed but the bookmark is not present (S201: Yes, S202: No), the audio and video reproducing apparatus is set in a mode of reproducing the HD DVD 23 from the beginning.

Also, when the presence of the bookmark is confirmed (S202: Yes), a message 11a as shown in FIG. 5 indicating the presence of the bookmark is displayed on the monitor 11 (S204), after the first image of the HD DVD 23 is displayed, for example, prompting the user to reply to whether or not the bookmark is used for the reproduction.

If the user selects the key corresponding to “Yes” on the screen of FIG. 5 with the remote controller 4 (S205: Yes), the MPU 14 reads the bookmark information (S206), sequentially reads the title information (title number) and the track information (S207, S208), jumps for the elapsed time (S209), and sets the HD DVD 23 at the position where the reproduction is stopped at S105 of FIG. 3 (S210). Thereby, it is possible to resume operation.

### Effects of the Embodiment

The embodiment of the present invention as described above has the following effects.

(1) Since the bookmark can be stored even when the HDMI between the audio and video reproducing apparatus 1 and the TV 3 is disconnected, the reproduction of the DVD can be started from the reproduction interrupt position after the recovery of the connection of the HDMI.

Unlike the legacy DVD, the HD DVD has the contents using the application called “Advanced Contents”. Among the contents, there is a bookmark function of storing the reproduction position of the HD DVD player. When the HDMI is disconnected, the position where the reproduction is interrupted can be stored as the bookmark information using this bookmark function. After the recovery of the connection of the HDMI, the reproduction is allowed from the interrupted position using the stored bookmark information.

(2) If the information as to whether or not the stored bookmark is used is displayed on the monitor 11 or the TV 3 as shown in FIG. 5, the user can make a choice of whether the reproduction is made from the previous stopped position or from the beginning of the DVD, whereby the user has a higher degree of freedom in the choice.

Though the audio and video reproducing apparatus 1 is the HD DVD player in the above embodiment, the audio and video reproducing apparatus 1 is not limited to the HD DVD player, because the information on the bookmark can be held within the electronic apparatus.

Also, when the recording medium is a writable disk, the reproduction can be resumed from the position where the reproduction is stopped by recording the bookmark information on the recording medium, even if the disk is reproduced on another electronic apparatus.

Also, when an operation of pulling the HD DVD or DVD out of the HD DVD drive 24 is performed, the bookmark and the corresponding information may be erased from the audio and video reproducing apparatus 1.

Also, though the connection of the audio and video reproducing apparatus 1 with the HDMI is made to the TV 3 in the above embodiment, the embodiment of the invention is not limited to the TV 3, but may be widely applicable to the electronic apparatuses to be connected with the HDMI, including the TV 3. Also, the digital interface is not limited to the HDMI, but may accord with any other interface standards as far as the connection information can be acquired.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope of the inventions.

What is claimed is:

1. An audio and video reproducing apparatus comprising:
an HD DVD drive that reproduces an HD DVD in accordance with HD DVD standards;
a digital interface that makes a connection between the HD DVD drive and another apparatus and transmits a reproduction signal of the HD DVD from the HD DVD drive to the another apparatus; and
a controller that stores an information regarding reproduction stop of the HD DVD and a bookmark corresponding to the information in a storage part using a bookmark function defined in the HD DVD standards, when the connection is disconnected during a playback of the HD DVD.

2. The audio and video reproducing apparatus according to claim 1,
wherein the controller stores the information regarding the reproduction stop and the bookmark corresponding to the information in a non-volatile memory when the power of the apparatus is turned off.

3. The audio and video reproducing apparatus according to claim 1, further comprising a display,
wherein the controller controls the display to display an indication whether the bookmark is used or not, when the connection is recovered and the existence of the bookmark is confirmed.

4. The audio and video reproducing apparatus according to claim 1,
wherein the controller performs the reproduction from the reproduction stop position using the bookmark when the connection is recovered.

5. The audio and video reproducing apparatus according to claim 1,
wherein the digital interface includes an HDMI.

6. The audio and video reproducing apparatus according to claim 5,
wherein the digital interface transmits the reproduction signal from the HD DVD drive to the another apparatus via the HDMI.

7. The audio and video reproducing apparatus according to claim 1, further comprising:
detection unit that detects a state of the connection.

8. An audio and video reproducing method comprising:
detecting a connection state with another apparatus when a DVD reproduction signal is transmitted to another apparatus via a digital interface; and
storing information regarding reproduction stop of the DVD when the connection is detected to be disconnected in the detecting the connection state.

9. The audio and video reproducing method according to claim 8,
wherein when the DVD is an HD DVD, the storing the information comprises storing the information regarding the reproduction stop and a bookmark corresponding to the information using a bookmark function defined in HD DVD standards.

10. The audio and video reproducing method according to claim 8,
wherein the detecting the connection state comprises transmitting the DVD reproduction signal to the another apparatus via an HDMI.
